(19) United States
(12) Patent Application Publication
(10) Pub. No.: US 2008/0073425 A1
(43) Pub. Date: Mar. 27, 2008

(54) Age verification system and method in electro-optical reader

(76) Inventors: Christopher Warren Brock, Manorville, NY (US); Duanfeng He, South Setauket, NY (US)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 11/526,784

(22) Filed: Sep. 25, 2006

(51) Int. Cl. G06K 5/00; G06K 7/10

(52) U.S. Cl. 235/380; 235/454

(57) ABSTRACT

Age is verified by electro-optically reading a date of birth in a machine-readable format on a target, and by comparing the date of birth with a current date or a latest acceptable date. An output signal is generated when the date of birth and the date differ by a predetermined time period.

### BACKGROUND OF THE INVENTION

Various electro-optical readers have previously been developed for reading bar code symbols appearing on a label, or on a surface of a target. The bar code symbol itself is a coded pattern of indicia. Generally, the readers electro-optically transform graphic indicia of the symbols into electrical signals, which are decoded into alphanumeric characters. The resulting characters describe the target and/or some characteristic of the target with which the symbol is associated. Such characters typically comprise input data to a data processing system for applications in point-of-sale processing, inventory control, article tracking and the like.

Moving beam electro-optical readers have been disclosed, for example, in U.S. Pat. No. 4,251,798; U.S. Pat. No. 4,369,361; U.S. Pat. No. 4,387,297; U.S. Pat. No. 4,409,470; U.S. Pat. No. 4,760,248; and U.S. Pat. No. 4,896,026, and generally include a light source consisting of a gas laser or semiconductor laser for emitting a laser beam. The laser beam is optically modified, typically by a focusing optical assembly, to form a beam spot having a certain size at a predetermined target location. The laser beam is directed by a scanning component along an outgoing optical path toward a target symbol for reflection therefrom. The reader operates by repetitively scanning the laser beam in a scan pattern, for example, a line or a series of lines across the target symbol by movement of the scanning component, such as a scan mirror, disposed in the path of the laser beam. The scanning component may sweep the beam spot across the symbol, trace a scan line across and beyond the boundaries of the symbol, and/or scan a predetermined field of view.

Moving beam electro-optical readers also include a photodetector, which functions to detect laser light reflected or scattered from the symbol. In some systems, the photodetector is positioned in the reader in a return path so that it has a field of view, which extends at least across and slightly beyond the boundaries of the symbol. A portion of the laser beam reflected from the symbol is detected and converted into an analog electrical signal. A digitizer digitizes the analog signal. The digitized signal from the digitizer is then decoded by a microprocessor, based upon a specific symbology used for the symbol, into a binary data representation of the data encoded in the symbol. The binary data may then be converted into the alphanumeric characters represented by the symbol. The data may be decoded locally or sent to, and decoded in, a remote host for subsequent information retrieval.

Moving beam electro-optical readers have been used for reading one-dimensional symbols each having a row of bars and spaces spaced apart along one direction, and for processing two-dimensional symbols, such as Code 49, as well. Code 49 introduced the concept of vertically stacking a plurality of rows of bar and space patterns in a single symbol. The structure of Code 49 is described in U.S. Pat. No. 4,794,239. Another two-dimensional code structure for increasing the amount of data that can be represented or stored on a given amount of surface area is known as PDF417 and is described in U.S. Pat. No. 5,304,786.

Both one- and two-dimensional symbols can also be read by employing solid-state imagers. For example, an image sensor device may be employed which has a one- or two-dimensional array of cells or photosensors which correspond to image elements or pixels in a field of view of the device. The array captures light from the symbol. Such an image sensor device may include a one- or two-dimensional charge coupled device (CCD) or a complementary metal oxide semiconductor (CMOS) device and associated circuits for producing electronic signals corresponding to a one- or two- dimensional array of pixel information over a field of view. The electronic signals may be processed by a microprocessor either locally or sent to, and processed in, a remote host to read the symbol.

Many states in the United States and many countries require their citizens to carry identification cards, such as drivers' licenses, in which one's date of birth, among other things, is provided in a human-readable format. This birth date information is useful in many transactions such as to grant or deny entry into a venue having certain age requirements, or to allow or disallow purchase of alcohol, tobacco, fireworks, or like products having age restrictions. However, birth date information in a human-readable format can be easily modified, thereby compromising the transactions.

As a result, many identification cards have been changed to provide information, including one's date of birth, in a machine-readable format, such as the two-dimensional PDF417 format described above. This machine-readable format cannot be easily modified and can only be read by an electro-optical reader, such as the moving beam and imaging readers described above. However, this art has not adopted parsing and reading birth date information from identification cards. It may be prohibited in some locales to transmit such personal information away from the readers to a remote host where the personal information is exposed to interception and abuse.

### SUMMARY OF THE INVENTION

One feature of this invention resides, briefly stated, in an age verification system and method, which comprise a reader for electro-optically reading a date of birth in a machine-readable format on a target; and a microprocessor in the reader for comparing the date of birth with a date, and for generating an output signal when the date of birth and the date differ by a predetermined time period. The reader may be an imaging reader including an array of sensors for capturing light from the target to derive the date of birth or a moving beam reader including a light source for scanning the target with a light beam, and for detecting light scattered from the target to derive the date of birth. In the preferred embodiment, the target is an identification card on which the date of birth is encoded in a two-dimensional symbol printed on the card.

Another feature of this invention resides in a memory operatively connected with the microprocessor for storing the date. The date may be a current date generated by a clock or date generator in the reader in real time. A remote host operatively connected with the microprocessor may also be used for transmitting the current date to the microprocessor. The date may be a latest acceptable date input by the operator or by the host. The microprocessor compares whether the date of birth differs from the latest acceptable date, i.e., is earlier than, the date of birth in order to generate the output signal. The microprocessor need not perform the comparison. In some applications, the date of birth is displayed to the operator, and the operator makes the comparison.

For increased security, the microprocessor is also operative for encrypting the date of birth. The memory operatively connected with the microprocessor may be used for storing the encrypted date of birth, and the encrypted date of birth may be transmitted to a remote host operatively connected with the microprocessor.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view of one embodiment of a portable electro-optical reader operative in either a hand-held mode, or in the illustrated workstation mode, equipped with an age verification system in accordance with this invention;

FIG. 2 is a perspective view of another embodiment of a portable electro-optical reader operative in either a hand-held mode, or in the illustrated workstation mode, equipped with an age verification system in accordance with this invention;

FIG. 3A is a perspective view of still another embodiment of a portable electro-optical reader operative in a workstation mode and equipped with an age verification system in accordance with this invention;

FIG. 3B is a perspective view of the embodiment of FIG. 3A in a hand-held mode and equipped with an age verification system in accordance with this invention;

FIG. 4 is a block circuit diagram of various components of an imager embodiment of the type shown in FIG. 1;

FIG. 5 is a block circuit diagram of various components of a moving beam embodiment of the type shown in FIGS. 3A, 3B; and

FIG. 6 is a block diagram of an age verification system for use in any of the reader embodiments.

### DETAILED DESCRIPTION OF THE PREFERRED EMBODIMENTS

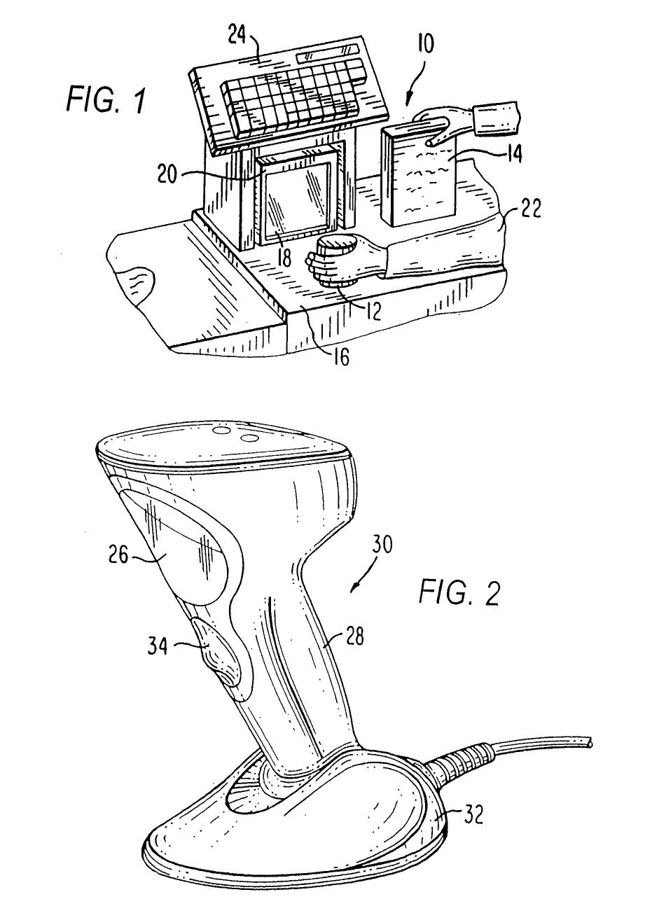

Reference numeral 10 in FIG. 1 generally identifies an electro-optical reader in a workstation mode for processing transactions and mounted on a checkout counter at a retail site at which products, such as a can 12 or a box 14, each bearing a target symbol, are processed for purchase. The counter includes a countertop 16 across which the products are slid at a swipe speed past a generally vertical window 18 of a box-shaped vertical slot reader 20 mounted on the countertop 16. A checkout clerk or operator 22 is located at one side of the countertop, and the reader 20 is located at the opposite side. A cash/credit register 24 is located within easy reach of the operator. The reader 20 is portable and lightweight and may be picked up from the countertop 16 by the operator 22, and the window 18 may be aimed at a symbol preferably on a product too heavy or too large to be easily positioned on the countertop in front of the reader in the workstation mode.

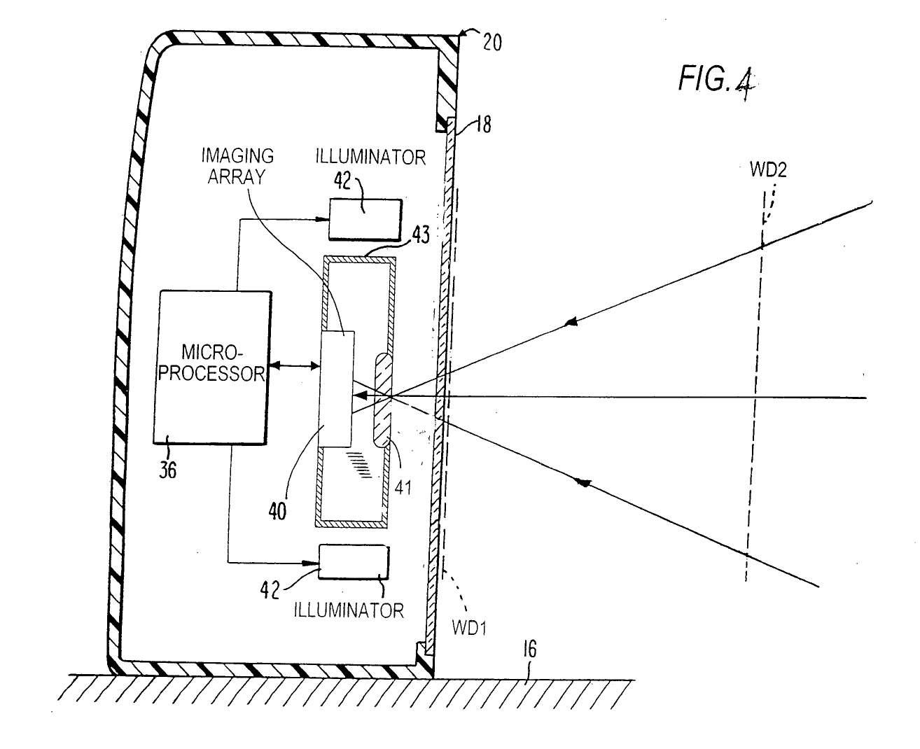

Reference numeral 30 in FIG. 2 generally identifies another portable, electro-optical reader having a different configuration from that of reader 20. Reader 30 also has a generally vertical window 26 and a gun-shaped housing 28 supported by a base 32 for directly supporting the reader 30 on a countertop. The reader 30 can thus be used as a stationary workstation in which products are slid or swiped past the generally vertical window 26, or can be picked up off the countertop and held in the operator's hand and used as a handheld reader in which a trigger 34 is manually depressed to initiate reading of the symbol.

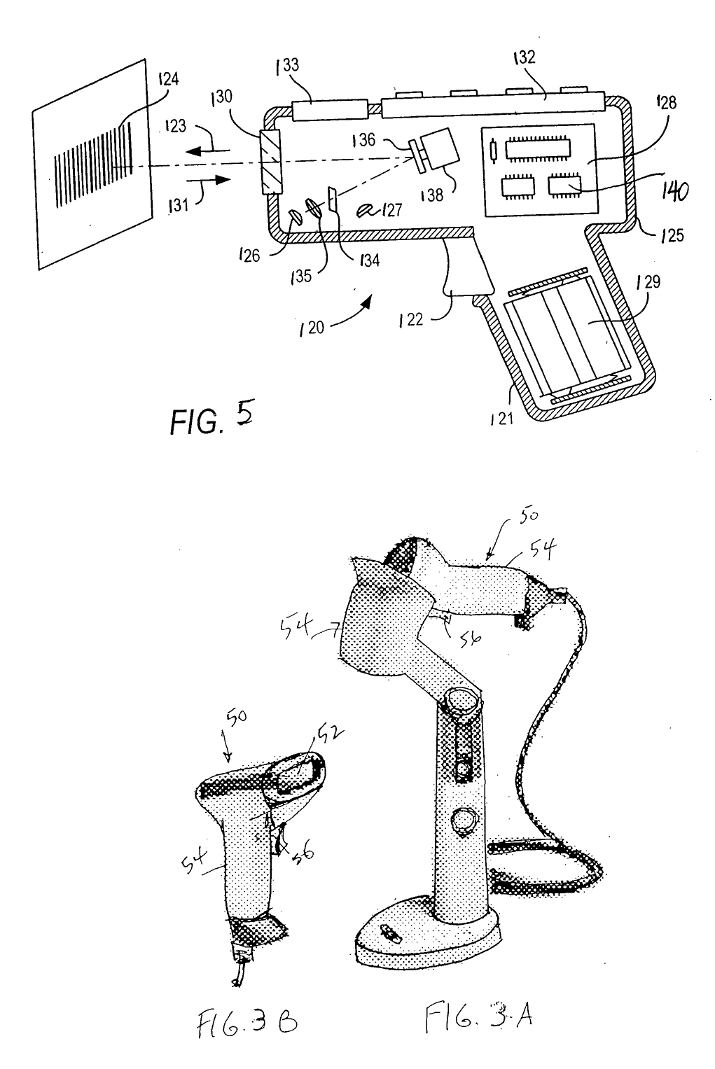

Reference numeral 50 in FIGS. 3A, 3B generally identifies another portable, electro-optical reader having yet another operational configuration from that of readers 20, 30. Reader 50 has a generally vertical window 52 and a gun-shaped housing 54 and is supported in a workstation mode (FIG. 3A) by a stand 54 on a countertop. The reader 50 can thus be used as a stationary workstation in which products are slid or swiped past the generally vertical window 26, or can be picked up off the countertop and held in the operator's hand in a handheld mode (FIG. 3B) and used as a handheld reader in which a trigger 56 is manually depressed to initiate reading of the symbol.

Each reader 20, 30, 50 includes, as shown for representative reader 20 in FIG. 4, an imager 40 and a focusing lens 41 that are mounted in an enclosure 43. The imager 40 is a solid-state device, for example, a CCD or a CMOS imager and has a linear or area array of addressable image sensors operative for capturing light through the window 18 from a target, for example, a one- or two-dimensional symbol, over a field of view and located in a working range of distances between a close-in working distance (WD1) and a far-out working distance (WD2). In a preferred embodiment, WD1 is about two inches from the imager array 40 and generally coincides with the window 18, and WD2 is about eight inches from the window 18. An illuminator 42 is also mounted in the reader and preferably includes a plurality of light sources, e.g., light emitting diodes (LEDs) 42, arranged around the imager 40 to uniformly illuminate the target symbol.

As shown in FIG. 4, the imager 40 and the illuminator 42 are operatively connected to a controller or microprocessor 36 operative for controlling the operation of these components. Preferably, the microprocessor is the same as the one used for decoding light scattered from the indicia and for processing the captured target symbol images.

In operation, the microprocessor 36 sends a command signal to the illuminator 42 to pulse the LEDs for a short time period of 500 microseconds or less, and energizes the imager 40 to collect light from a target symbol substantially only during said time period. A typical array needs about 33 milliseconds to read the entire target image and operates at a frame rate of about 30 frames per second. The array may have on the order of one million addressable image sensors.

The imager 40 itself should have a global electronic shutter in which all the sensors are simultaneously exposed for light capture. Most CCD arrays are designed with a global electronic shutter. A typical CMOS array is designed with a rolling electronic shutter in which different sensors are exposed at different times. If such a CMOS array is used, then it must be designed to allow a global electronic shutter.

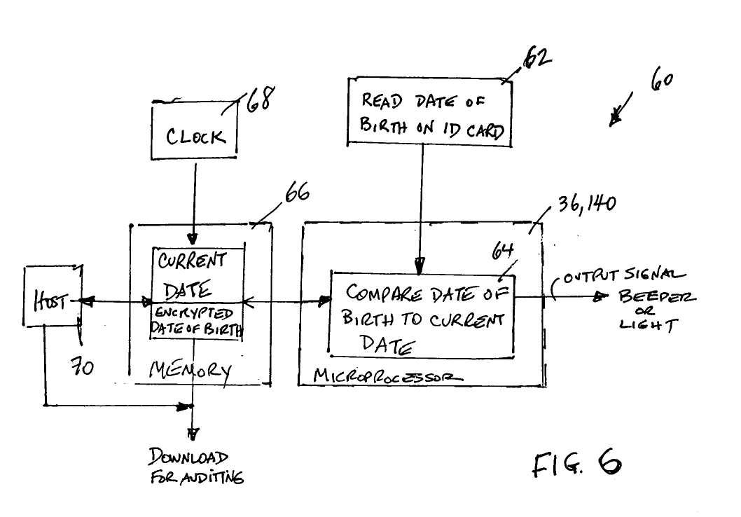

Reference numeral 120 in FIG. 5 generally identifies a hand-held, retro-collective reader for electro-optically reading a target, such as bar code symbol 124, located in a range of working distances therefrom. The reader 120 has a pistol grip handle 121 and a manually actuatable trigger 122, which, when depressed, enables a light beam 123 to be directed at the symbol 124. The reader 120 includes a housing 125 in which a light source 126, a light detector 127, signal processing circuitry 128, and a battery pack 129 are accommodated. A light-transmissive window 130 at a front of the housing enables the light beam 123 to exit the housing, and allows light 131 scattered off the symbol to enter the housing. A keyboard 132 and a display 133 may advantageously be provided on a top wall of the housing for ready access thereto.

In use, an operator holding the handle 121 aims the housing at the symbol and depresses the trigger. The light source 126 emits the light beam 123, which is optically modified and focused by focusing optics 135 to form a beam spot on the symbol 124. The beam passes through a beam splitter 134 to a scan mirror 136 which is repetitively oscillated at a scan rate of at least 20 scans a second by a motor drive 138. The scan mirror 136 reflects the beam incident thereon along an outgoing optical path to the symbol 124 for reflection therefrom and sweeps the beam spot across the symbol in a scan pattern. The scan pattern can be a line extending lengthwise along the symbol along a scan direction, or a series of lines arranged along mutually orthogonal directions, or an omnidirectional pattern, just to name a few possibilities.

The reflected light 131 has a variable intensity over the scan pattern and passes through the window 130 along a return path coincident with the outgoing path onto the scan mirror 136 where it is collected and reflected onto the splitter 134 and, in turn, reflected to the photodetector 127 for conversion to an analog electrical signal. Signal processing circuitry 128 digitizes and decodes the signal under control of a microprocessor 140 to extract the data encoded in the symbol.

The components depicted in FIG. 5 can be provided in each reader 20, 30, 50. Hence, each reader configuration can be an imaging reader or a moving beam reader.

In accordance with this invention, an age verification system 60, as shown in FIG. 6, is incorporated in a respective reader. Advantageously, the target is a two-dimensional symbol printed on an identification card, such as a driver's license. The reader is operative for electro-optically reading, as exemplified by block 62, a date of birth encoded in the two-dimensional symbol. The microprocessor 36, 140 in the respective reader is operative, as exemplified by block 64, for comparing the date of birth with a date, and for generating an output signal when the date of birth and the date differ by a predetermined time period.

Preferably, a memory 66 is operatively connected with the microprocessor 36, 140 for storing the date. The current date may be generated in real time by a date generator or clock 68 in the reader and stored in the memory 66. Alternatively, a remote host 70 may be operatively connected with the memory 66 for transmitting the current date to the microprocessor. Thus, the clock 68 may also be in the host. The current date may be transmitted periodically, or once upon initial start-up of the reader. A target date can be hard-wired into the memory or loaded in the memory by reading a specially configured bar code symbol.

For increased security, the microprocessor 36, 140 is also operative for encrypting the date of birth. The memory 66 is also operative for storing the encrypted date of birth. The microprocessor is operative for transmitting the encrypted date of birth to the remote host 70 operatively connected with the microprocessor. Authorized personnel can download such stored encrypted dates of birth for auditing purposes. Such authorized personnel are given a decryption key to view the stored encrypted dates of birth. After a preestablished time interval, the stored encrypted dates of birth can be automatically purged.

The comparison between the birth date and the current date is useful in many situations. For example, if the predetermined time period is less than eighteen years old, then this underage information is used in some jurisdictions to deny entry into a voting booth or a movie theater. This underage information can also be advantageously used in a retail setting to deny purchase of alcohol, tobacco, fireworks, or like products to minors. In other jurisdictions, the predetermined time period can be twenty-one years old, or any time period in which one decision is made when the predetermined time period is less than a predetermined value, and another decision is made when the predetermined time period is more than the predetermined value. For example, entry into a certain venue can be permitted only to customers over fifty years of age.

The output signal can be visual or auditory. A beeper on the reader can sound a distinctive sound, or a light on the reader can be illuminated with a distinctive light pattern, when the date of birth and the current date differ by a predetermined time period. “Go” or “no-go” indicators are used to convey the results of the comparison.

The age verification system need not be performed by comparing the date of birth with the current date. In some applications where the reader or the host have no time/date functionality, the latest acceptable date can be loaded by the operator via the keyboard or by reading a specially configured symbol, or by the host, and then the microprocessor compares whether the date of birth differs from the latest acceptable date, i.e., is earlier than, the date of birth in order to generate the output signal. Also, the microprocessor need not perform the comparison. In some applications, the date of birth is displayed to the operator, and the operator makes the comparison.

The age verification system is performed entirely within the reader. The date of birth information in unencrypted form is not downloaded away from the reader such that this personal information cannot be intercepted and stolen, and the comparison is not performed off the reader.

It will be understood that each of the elements described above, or two or more together, also may find a useful application in other types of constructions differing from the types described above. For example, the age to be verified need not be of a person, but can be the age of a product. An out-of-date product can be discarded, while an in-date product can be kept.

While the invention has been illustrated and described as embodied in an age verification system in an electro-optical reader and method, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims.

We claim:

1. An age verification system, comprising:
a) a reader for electro-optically reading a date of birth in a machine-readable format on a target; and
b) a microprocessor in the reader for comparing the date of birth with a date, and for generating an output signal when the date of birth and the date differ by a predetermined time period.

2. The system of claim 1, wherein the reader is an imaging reader including an array of sensors for capturing light from the target to derive the date of birth.

3. The system of claim 1, wherein the reader is a moving beam reader including a light source for scanning the target with a light beam, and for detecting light scattered from the target to derive the date of birth.

4. The system of claim 1, wherein the target is an identification card on which the date of birth is encoded in a two-dimensional symbol printed on the card.

5. The system of claim 1, and a memory operatively connected with the microprocessor for storing the date.

6. The system of claim 1, and a date generator for generating in real time a current date as the date.

7. The system of claim 1, and a remote host operatively connected with the microprocessor, and wherein the date generator is in the host for transmitting the current date to the microprocessor.

8. The system of claim 1, wherein the date is a latest acceptable date, and wherein the microprocessor is operative for generating the output signal when the date of birth differs from the latest acceptable date.

9. The system of claim 1, wherein the microprocessor is also operative for encrypting the date of birth.

10. The system of claim 9, and a memory operatively connected with the microprocessor for storing the encrypted date of birth, and wherein the microprocessor is operative for transmitting the encrypted date of birth to a remote host.

11. An age verification system, comprising:
a) reader means for electro-optically reading a date of birth in a machine-readable format on a target; and
b) microprocessor means in the reader means for comparing the date of birth with a date, and for generating an output signal when the date of birth and the date differ by a predetermined time period.

12. A method of verifying age, comprising the steps of:
a) electro-optically reading a date of birth in a machine-readable format on a target; and
b) comparing the date of birth with a date, and for generating an output signal when the date of birth and the date differ by a predetermined time period.

13. The method of claim 12, wherein the electro-optically reading step is performed by capturing light from the target to derive the date of birth.

14. The method of claim 12, wherein the electro-optically reading step is performed by scanning the target with a light beam, and by detecting light scattered from the target to derive the date of birth.

15. The method of claim 12, and the step of encoding and printing the date of birth in a two-dimensional symbol on an identification card.

16. The method of claim 12, and storing the date in a memory.

17. The method of claim 12, and generating the date in real time.

18. The method of claim 12, and transmitting the date from a remote host.

19. The method of claim 12, wherein the date is a latest acceptable date, and wherein the comparing step is performed by generating the output signal when the date of birth differs from the latest acceptable date.

20. The method of claim 11, and encrypting the date of birth.

21. The method of claim 20, and storing the encrypted date of birth, and transmitting the encrypted date of birth to a remote host.

22. The method of claim 19, and downloading the stored encrypted date of birth.
